(19) United States
(12) Patent Application Publication
(10) Pub. No.: US 2014/0028917 A1
(43) Pub. Date: Jan. 30, 2014

(54) DISPLAYING MULTIMEDIA

(71) Applicants: Alfonso Martinez Smith, Algonquin, IL (US); Kevin L. Baum, Rolling Meadows, IL (US); Anthony J. Braskich, Palatine, IL (US); Stephen P. Emeott, Rolling Meadows, IL (US); Faisal Ishtiaq, Chicago, IL (US); Renxiang Li, Lake Zurich, IL (US); Isselmou Ould Dellahy, Lake in the Hills, IL (US)

(72) Inventors: Alfonso Martinez Smith, Algonquin, IL (US); Kevin L. Baum, Rolling Meadows, IL (US); Anthony J. Braskich, Palatine, IL (US); Stephen P. Emeott, Rolling Meadows, IL (US); Faisal Ishtiaq, Chicago, IL (US); Renxiang Li, Lake Zurich, IL (US); Isselmou Ould Dellahy, Lake in the Hills, IL (US)

(73) Assignee: GENERAL INSTRUMENT CORPORATION, Horsham, PA (US)

(21) Appl. No.: 13/561,222

(22) Filed: Jul. 30, 2012

(51) Int. Cl. H04N 5/445

(52) U.S. Cl. 348/564; 348/E05.099

(57) ABSTRACT

Disclosed are methods and apparatus for displaying multimedia feeds. The method comprises receiving a plurality of multimedia feeds and, for each of the plurality of multimedia feeds, acquiring a value of a metric and displaying, on a common display, the plurality of multimedia feeds. The metric is variable and its value for a particular multimedia feed and for a particular time is dependent upon either events occurring within that particular multimedia feed at or before that particular time or upon a rating (by one or more entities), at that particular time, of that particular multimedia feed. The multimedia feeds are displayed on the common display such that a first feed is displayed in a manner different from the manner of display of a second feed, the first feed having a first metric value, the second feed having a second metric value, and the first and second metric values being different.

### FIELD OF THE INVENTION

The present invention is related generally to displaying multimedia fields.

### BACKGROUND OF THE INVENTION

Typically, if several multimedia feeds are simultaneously provided for consumption to a consumer, it may be difficult for that consumer to identify which of the provided feeds are the most interesting or relevant to him, e.g., so that the consumer may focus his attention on that feed.

For example, if several video or television feeds are simultaneously displayed (e.g., on a television) to a consumer, it tends to be difficult for that consumer to identify the most interesting or exciting feed. It also tends to be difficult for that consumer to identify feeds in which contextually important events are occurring.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) showing an example system in which embodiments of a method of video-feed enhancement can be implemented;

FIG. 2 is a schematic illustration (not to scale) of a television;

FIG. 3 is a process flow-chart showing certain steps of an embodiment of the method of video-feed enhancement; and

FIG. 4 is a schematic illustration (not to scale) showing an example of how television feeds may be displayed.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Embodiments of the invention provide techniques for identifying and enhancing (e.g., visually enhancing) one or more multimedia feeds (e.g., video feeds) from a plurality of such feeds that are simultaneously being presented (e.g., displayed) to the user. This identification and enhancement may be based on media analysis performed on the plurality of feeds, e.g., in a runtime or in a pre-processed fashion. This media analysis may be customized for or by the user.

Apparatus for implementing any of the below described arrangements, and for performing any of the below described method steps, may be provided by configuring or adapting any suitable apparatus, for example one or more computers or other processing apparatus or processors or by providing additional modules. The apparatus may comprise a computer, a network of computers, or one or more processors for implementing instructions and using data, including instructions and data in the form of a computer program or a plurality of computer programs stored in or on a machine-readable storage medium such as computer memory, a computer disk, ROM, PROM, etc., or any combination of these or other storage media.

It should be noted that certain of the process steps depicted in the below described process flowcharts may be omitted or such process steps may be performed in an order differing from that presented below and shown in those process flowcharts. Furthermore, although all the process steps have, for convenience and ease of understanding, been depicted as discrete temporally-sequential steps, nevertheless some of the process steps may in fact be performed simultaneously or at least overlapping to some extent temporally.

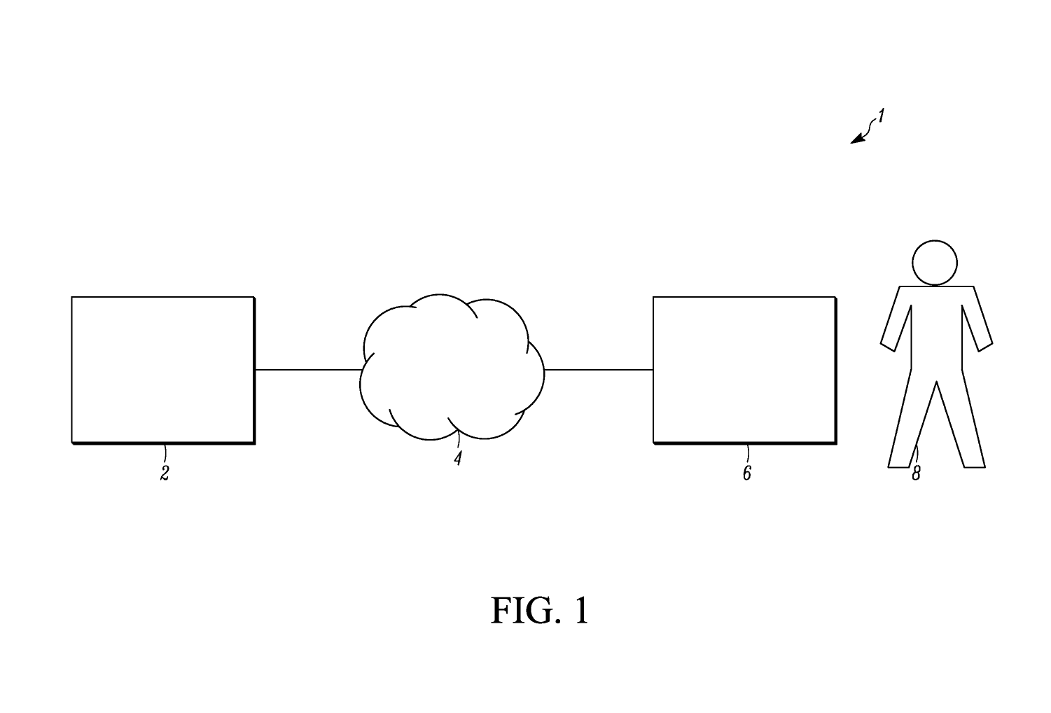

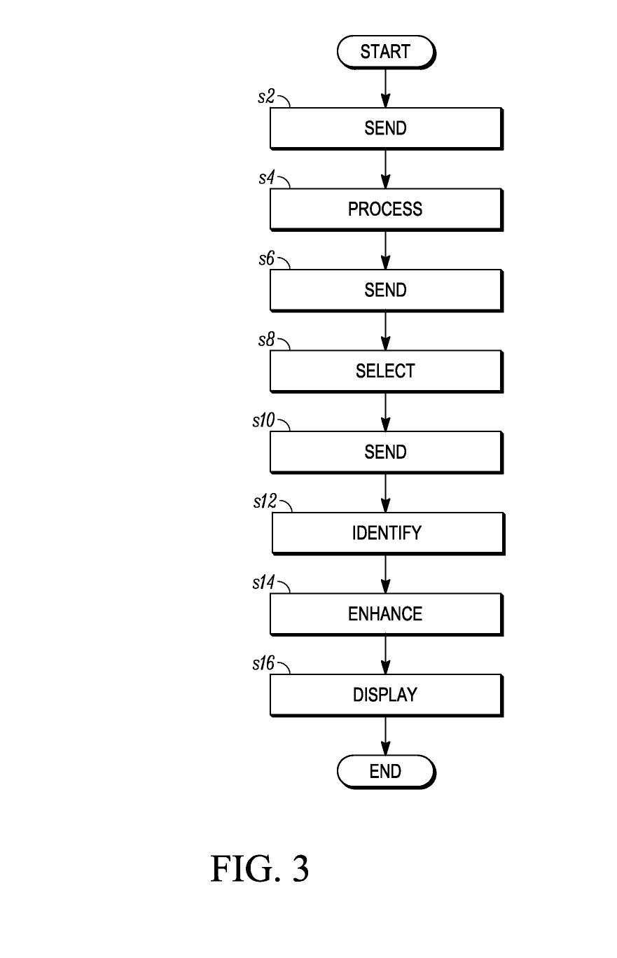

Referring now to the Figures, FIG. 1 is a schematic illustration (not to scale) showing an example system 1 in which embodiments of a method of video-feed enhancement can be implemented. An embodiment of the method of video-feed enhancement is described in more detail below with reference to FIG. 3. In other embodiments, the method of video-feed enhancement may be implemented in a different way that may, for example, comprise one or more different entities instead of or in addition to those shown in FIG. 1.

The system 1 comprises a service provider 2, a network 4, a television (TV) 6, and a user 8.

In other embodiments, a different type of audiovisual-reception client (e.g., a tablet computer, a smartphone, etc.) may be used instead of or in addition to the TV 6.

The service provider 2 may be a provider of cable-television or satellite-television services. The service provider 2 is a provider of a plurality of TV feeds. Each of the TV feeds may be for a different TV program. For example, each TV feed may be a TV feed for a different sporting event. Also, one or more of the TV feeds may relate to the same event (e.g., a sporting event, a political rally, etc.) but may be from different camera angles, broadcasters, etc. The service provider 2 is connected (e.g., via the network 4) to the TV 6. This connection is such that the TV feeds provided by the service provider 2 may be sent from the service provider 2 to the TV 6 via the network 4. In other embodiments, the service provider 2 may be an Internet site or service that provides multimedia feeds or clips (e.g., Hulu™, YouTube™, etc.). In other embodiments, there may be a plurality of service providers 2 each of which may provide multimedia content.

The network 4 may be any appropriate network, for example, a cable-television network, a satellite-television network, the Internet, or a combination of those networks. In embodiments in which a plurality of service providers 2 (e.g., different types of service provider 2) provide multimedia content to a client device 6, the multimedia content may be provided over a plurality of networks 4 (e.g., different types of network 4). For example, each service provider 2 may provide multimedia content to a client device 6 via a different network 4. The client device 6 (e.g., a TV) may be capable of receiving multimedia content over each of the networks 4 used. Furthermore, the client device 6 may be capable of receiving multimedia content simultaneously over the plurality of networks 4.

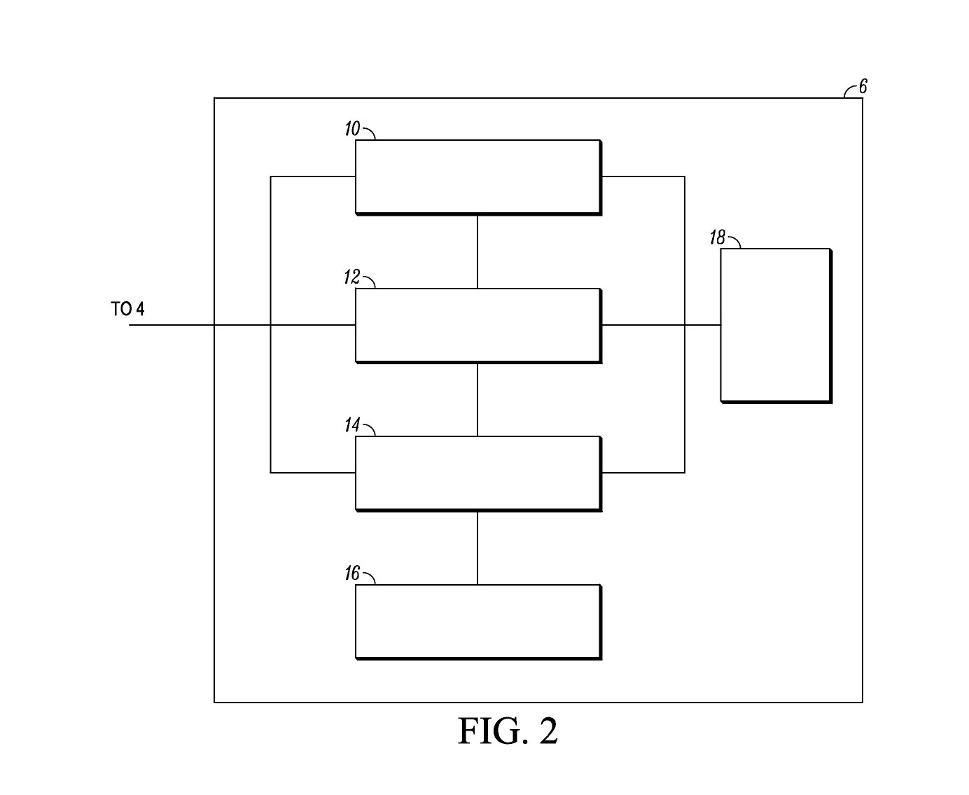

The TV 6 is described in more detail below with reference to FIG. 2. The TV 6 is configured to receive the TV feeds sent to it from the service provider 2. The TV 6 is configured to process the received TV feeds as described in more detail below with reference to FIG. 3. The TV 6 is configured to display one or more of the TV feeds to the user 8 as described in more detail below with reference to FIG. 3.

The user 8 is a user of the TV 6.

FIG. 2 is a schematic illustration (not to scale) of the TV 6.

The TV 6 may comprise a media-analysis module 10, a selection module 12, an enhancement module 14, a display 16, and a user input 18.

In other embodiments, one or more of the modules 10 through 18 may be located remotely from the TV 6. In other words, the functionality of the TV 6 in this embodiment may be provided, in other embodiments, by one or more differently arranged modules. For example, in other embodiments one or more of the modules 10 through 14 may be located remotely from the TV 6 (which may comprise the display 16 and the user input 18) and may be connected to the TV 6 via the network 4. For example, the modules 10 through 14 may be located in the “cloud” rather than in the TV 6. Also for example, in other embodiments one or more of the modules 10 through 14 may be located in one or more separate computing devices (devices that are different from to the TV 6) that may communicate with the TV 6 (e.g., via a wired or wireless communications link) such that information may be transferred among the TV 6 and one or more of the separate computing devices.

In this embodiment, the media-analysis module 10 may be connected to the service provider 2 via the network 4 such that the media-analysis module 10 may receive the plurality of TV feeds sent to the TV 6 from the service provider 2. The media-analysis module 10 may be configured to process the received TV feeds as described in more detail below with reference to FIG. 3. This processing may be performed to determine, for each of the received TV feeds, values of one or more metrics. The media-analysis module 10 may be connected to the selection module 12 and to the enhancement module 14 such that information (e.g., the metric values determined by the media-analysis module 10) may be sent from the media-analysis module 10 to each of the selection module 12 and the enhancement module 14. The media-analysis module 10 may also be connected to the user input 18 such that information input (e.g., by the user 8) at the user input 18 may be sent from the user input 18 to the media-analysis module 10. The information input at the user input 18 may be used by the media-analysis module 10 during the processing of the TV feeds.

The selection module 12 may be connected to the service provider 2 via the network 4 such that the selection module 12 may receive the plurality of TV feeds sent to the TV 6 from the service provider 2. The selection module 12 may be configured to process the received TV feeds as described in more detail below with reference to FIG. 3. This processing may comprise using the information sent to the selection module 12 from the media-analysis module 10 (e.g., the determined metric values). Also, this processing may be performed to select one or more of the TV feeds. The selection module 12 may be connected to the enhancement module 14 such that information (e.g., information specifying which TV feeds have been selected by the selection module 12) may be sent from the selection module 12 to the enhancement module 14. The selection module 12 may also be connected to the user input 18 such that information input (e.g., by the user 8) at the user input 18 may be sent from the user input 18 to the selection module 12. The information input at the user input 18 may be used by the selection module 12 during the processing of the TV feeds.

The enhancement module 14 may be connected to the service provider 2 via the network 4 such that the enhancement module 14 may receive the plurality of TV feeds sent to the TV 6 from the service provider 2. The enhancement module 14 may be configured to process the received TV feeds as described in more detail below with reference to FIG. 3. This processing may comprise using the information sent to the enhancement module 14 from the media-analysis module 10 (e.g., the determined metric values). Also, this processing may comprise using the information sent to the enhancement module 14 from the selection module 12 (e.g., information specifying which TV feeds have been selected by the selection module 12). Also, this processing may be performed to enhance one or more of the TV feeds. The terminology “enhancing a TV feed” is used herein to refer to processing performed on a TV feed such that, when displayed, that TV feed is displayed differently from how an unenhanced TV feed would be displayed. For example, an enhanced TV feed may be displayed in a display window on a display screen larger than that in which an unenhanced TV feed would be displayed, an enhanced TV feed may be displayed at a resolution higher than that with which an unenhanced TV feed would be displayed, an enhanced TV feed may be displayed with an aspect ratio different from that with which an unenhanced TV feed would be displayed, an enhanced TV feed may have its audio played, whilst unenhanced TV feeds may not have their audio played, etc.

The enhancement module 14 may be connected to the display 16 such that information (e.g., enhanced or unenhanced TV feeds) may be sent from the enhancement module 14 to the display 16. The enhancement module 14 may also be connected to the user input 18 such that information input (e.g., by the user 8) at the user input 18 may be sent from the user input 18 to the enhancement module 14. The information input at the user input 18 may be used by the enhancement module 14 during the processing of the TV feeds.

The display 16 may be configured to display the TV feeds sent to it from the enhancement module 14 as described in more detail below with reference to FIG. 3.

The user input 18 may be any appropriate device, means, or interface using which the user 8 may input information into the TV 6 (e.g., for use by the media-analysis module 10, by the selection module 12, or by the enhancement module 14).

FIG. 3 is a process flow-chart showing certain steps of an embodiment of the method of video-feed enhancement as may be performed by elements of the system 1.

At step s2, the service provider 2 sends, via the network 4, the plurality of TV feeds to the TV 6. In particular, the plurality of TV feeds may be sent to the media-analysis module 10, to the selection module 12, and to the enhancement module 14.

At step s4, the media-analysis module 10 processes the received plurality of TV feeds. The media-analysis module 10 may, for each of the plurality of TV feeds, determine a value of one or more metrics.

A metric determined at step s4 may be any appropriate metric. For example, one or more of the metrics may be measures of how exciting a TV feed is. In other words, a metric value determined for a TV feed may be indicative of how exciting events occurring in that TV feed are deemed to be. Such metrics may be thought of as “excitement metrics.” An example excitement metric is that determined by Thuuz™.

A metric determined at step s4 may be a function or combination of any number of other metric values. For example, a metric value determined at step s4 may be a weighted combination of a plurality of other metric values.

A metric determined at step s4 may be dependent upon any parameters that are related to the TV feeds. Such parameters related to a TV feed may include, but are not limited to:
a number of current “likes” for that TV feed from members of a social network of the user 8,
a source-generated rating for that TV feed,
a detected presence of a specific actor or object (e.g., as specified by the user 8) in that TV feed, and
a detected discussion of or reference to a specific topic (e.g., a subject, event, person, or story, as specified by the user 8) in that TV feed.

The media-analysis module 10 may comprise one or more detectors for determining the metric values. For example, the media-analysis module 10 may comprise an “excitement detector” (for detecting a level of excitement in a TV feed), a “social activity detector” (for detecting activity in one or more of the user's social networks related to a TV feed), an “object detector” (for detecting the presence of a specific object in a TV feed), etc. One or more of the detectors may monitor or analyze only some of the content of a TV feed, such as the audio track, the video track, individual frames from the video track, or the closed-captioning text associated with the TV feed. For example, an object detector that is monitoring for the presence of a car may analyze frames from the video track for the presence of car-shaped objects, or analyze the audio track for car-engine sounds, or analyze the closed-caption text for words associated with cars or driving. A detector may combine two or more types of analysis. This tends to improve robustness.

In this embodiment, the metric values may be determined automatically by one or more processors (i.e., by the media-analysis module 10). However, in other embodiments, one or more of the metric values may be determined in a different way, e.g., by a human.

The user 8 may select which metrics are determined at step s4 or how those metrics are determined. The user 8 may specify which parameters or data sources are used to determine the metric values. The user 8 may specify such information, for example, by inputting his preferences in to the media-analysis module 10 using the user input 18. Alternatively, the user 8 may specify a “user profile” which may specify such information and may be accessed by the media-analysis module 10. The user profile could be entered, stored, and accessed in any appropriate way. For example, the user 8 may input profile information into a web-site designed to capture and store such information. Also for example, one or more processors may analyze the user behaviour (e.g., the user's viewing habits or social networking behaviour) to learn the user preferences or to derive profile information.

At step s6, the one or more metric values that have been determined for each of the TV feeds are sent from the media-analysis module 10 to the selection module 12 and to the enhancement module 14.

At step s8, using the received metric values, the selection module 12 may select one or more of the plurality of TV feeds received by the TV 6. The selection module 12 may select one or more of the plurality of TV feeds for display to the user 8 as described in more detail below at step s16. The selection of a TV feed by the selection module 12 may depend on the metric values corresponding to that TV feed relative to the metric values corresponding to other TV feeds.

The selection of one or more TV feeds from the plurality of TV feeds may be in accordance with any appropriate criteria. For example, if the metric values determined for each the TV feeds are indicative of the level of excitement of that TV feed, then the selection module 12 may select the subset of the plurality of TV feeds that correspond to the highest metric values (i.e., the highest excitement levels). In other words, the selection module 12 may select the most exciting TV feeds from the plurality of received TV feeds. For example, if twenty TV feeds are sent from the service provider 2 to the TV 6, then the selection module 12 may select from those twenty TV feeds the six TV feeds that correspond to the highest excitement levels (i.e., the TV feeds that correspond to the six highest metric values).

The one or more TV feeds selected by the selection module 12 are hereinafter referred to as the “selected TV feeds.”

The user 8 may specify one or more of the criteria that are used, by the selection module 12, to select one or more TV feeds from the plurality of TV feeds. The user 8 may specify these criteria, for example, by inputting the criteria in to the selection module 12 using the user input 18. Alternatively, the user 8 may specify a “user profile” which may specify such criteria and may be accessed by the selection module 12.

At step s10, information specifying the selected TV feeds is sent from the selection module 12 to the enhancement module 14.

At step s12, using the information received from the media-analysis module 10 (i.e., the metric values determined for each of the TV feeds) and the information received from the selection module 12 (i.e., the information specifying the selected TV feeds), the enhancement module 14 may identify one or more of the of the selected TV feeds for enhancement.

Any appropriate criteria may be used to identify which of the selected TV feeds are to be enhanced. For example, the TV feed corresponding to the highest excitement metric value (i.e., the most exciting TV feed) may be identified as the only TV feed to be enhanced.

The user 8 may specify one or more of the criteria that are used, by the enhancement module 14, to identify one or more TV feeds from the selected TV feeds. The user 8 may specify these criteria, for example, by inputting the criteria in to the enhancement module 14 using the user input 18. Alternatively, the user 8 may specify a “user profile” which may specify such criteria and may be accessed by the enhancement module 14.

At step s14, the one or more TV feeds identified at step s12 may be processed by the enhancement module 14 so that, when displayed (at step s16) those TV feeds are enhanced. In other words, the one or more TV feeds identified at step s12 may be processed by the enhancement module 14 so that, when displayed, they are displayed differently from the other TV feeds (i.e., from the unenhanced TV feeds). For example, the one or more TV feeds identified at step s12 may be processed by the enhancement module 14 so that, when displayed, they are displayed in a larger display window on the display 16 than are the TV feeds that were not identified at step s12.

The enhancements applied to one or more of the selected TV feeds may be any appropriate enhancements. For example, enhancements may be such that an enhanced TV feed is displayed in a different size display window, in a different shape display window, at a different resolution, with a different aspect ratio, at a different location on a display, etc., when compared with an unenhanced TV feed. Also, the type or level of enhancement applied to a TV feed may be dependent upon the metric values corresponding to that TV feed. For example, the selected TV feeds may be processed so that, when those TV feeds are displayed, the relative sizes of display windows that those TV feeds are displayed in reflect the relative magnitudes of the metric values corresponding to those TV feeds (e.g., a TV feed corresponding to a relatively large metric value would be displayed in a relatively large display window, whilst a TV feed corresponding to a relatively small metric value would be displayed in a relatively small display window).

The user 8 may specify one or more of the enhancements that may be applied to one or more of the selected TV feeds by the enhancement module 14. The user 8 may specify these enhancements, for example, by inputting enhancement selections in to the enhancement module 14 using the user input 18. Alternatively, the user 8 may specify a “user profile” which may specify desired enhancements and may be accessed by the enhancement module 14.

At step s16, the enhancement module 14 may display, on the display 16, the selected TV feeds. One or more of these selected TV feeds may have been enhanced at step s14 such that those enhanced TV feeds are displayed differently from the unenhanced TV feeds. For example, enhanced TV feeds may be displayed, on the display 16, in a different size display window, in a different shape display window, at a different resolution, with a different aspect ratio, at a different location on a display, etc., when compared with unenhanced TV feeds.

The selected TV feeds may be displayed in any appropriate way, configuration, or format. For example, the TV feeds may be displayed in a circular configuration. Alternatively, the TV feeds may be displayed such that the one or more enhanced TV feeds are displayed in one portion of the display 16, whilst the other, unenhanced, TV feeds are displayed in a different portion of the display 16.

The user 8 may specify a way, configuration, or format in which the selected TV feeds may be displayed on the display 16. The user 8 may specify these, for example, by inputting display specifications in to the enhancement module 14 using the user input 18. Alternatively, the user 8 may specify a “user profile” which may specify display specifications and may be accessed by the enhancement module 14.

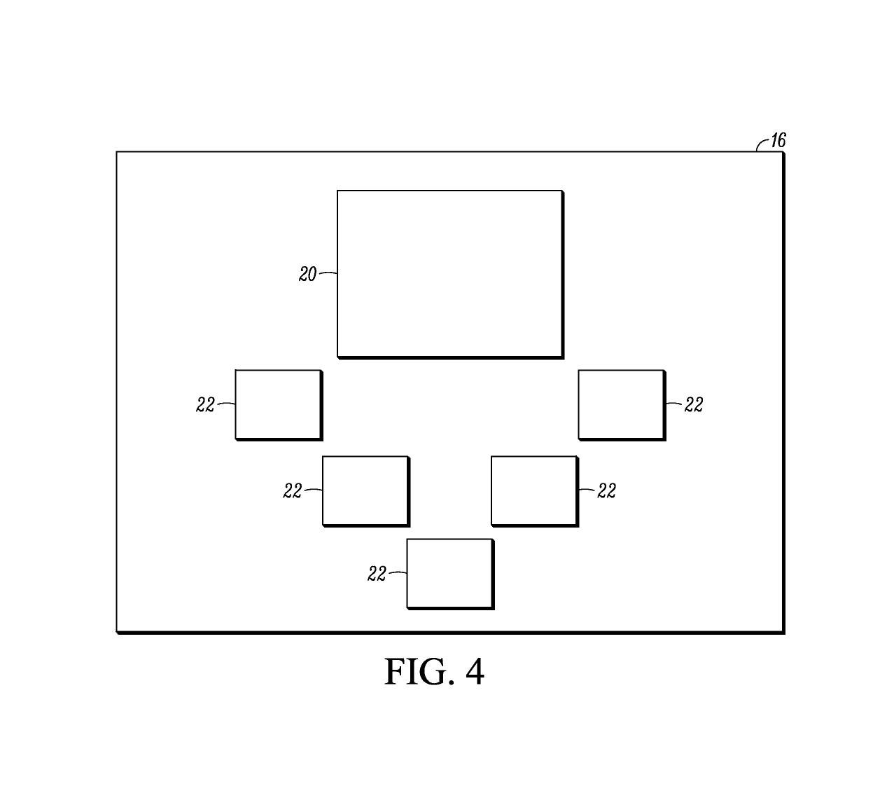

FIG. 4 is a schematic illustration (not to scale) showing an example of how the selected TV feeds may be displayed on the display 16 at step s16.

In this example, a single TV feed has been enhanced so that it is displayed in a larger display window than the ones used for the other unenhanced TV feeds. In FIG. 4 the enhanced TV feed and the display window in which it is displayed are indicated by the reference numeral 20, whereas unenhanced TV feeds and the display windows in which they are displayed are indicated by the reference numeral 22. In this example, there are a total of six TV feeds (i.e., six TV feeds have been selected at step s8 for display). In particular, there is a single enhanced TV feed 20 and five unenhanced TV feeds 22. Also, in this example, the selected TV feeds 20, 22 are displayed on the display 16 in a circular formation. The audio track of the enhanced TV feed 20 may be played, whilst the audio tracks of the unenhanced TV feeds 22 may be muted.

Thus, a method of video-feed enhancement is provided.

An advantage provided by the above described system and method is that a number of TV feeds may be monitored, and only those that are determined to be the most exciting or interesting, etc., (as measured using some metric) are displayed to the user 8. If exciting or interesting, etc., events occur in a TV feed that is not currently being displayed to a user 8 (such that that hidden TV feed becomes more exciting or interesting than one or more of the TV feeds currently being displayed), then that hidden feed may replace a less exciting or interesting TV feed that is currently being displayed. This replacement may be based on any appropriate replacement policy. This replacement of one TV feed with another may be performed automatically (e.g., without requiring the user's permission to perform), or the user 8 may be asked for permission to perform the replacement.

A further advantage provided by the above described system and method is that, of the TV feeds that are displayed to the user 8, one or more of the most exciting or interesting, etc., (as measured using some metric) TV feeds may be highlighted to the user 8, i.e., one or more of the most exciting or interesting, etc., TV feeds may be enhanced. This tends to draw the user's attention to events that the user 8 may regard as the most exciting or interesting, etc. If exciting or interesting, etc., events occur in an unenhanced TV feed (such that the unenhanced TV feed becomes more exciting or interesting than an enhanced TV feed), then that unenhanced TV feed may be enhanced. Also, the currently enhanced TV feed may be unenhanced. This enhancement change may be performed automatically (e.g., without requiring the user's permission to perform), or the user 8 may be asked for permission to perform the replacement. A display size of a de-emphasized TV feed may, for example, correspond to its relative excitement level with respect to other TV feeds.

Any interactive prompts that ask for user permission to change which feeds are being displayed to the user 8 or how those feeds are displayed may be disabled, e.g., by the user 8. Thus, a user 8 can choose to not be disturbed by interactive prompts if he so wishes. For example, if the user 8 wishes to watch a currently enhanced TV feed and has no interest in watching another feed, then the user 8 may disable the updating of the TV feeds or may select that currently enhanced TV feed as the only feed for display.

The above described system and method advantageously tend to improve the ability of a user 8 to find content that is of interest to that user 8.

The above described method may be implemented as a web-based service that is capable of enhancing a content search experience of a user 8. Alternatively, the above described method may be implemented as an application (or suite of applications) running on a user device 6. The above described method may be implemented in a “smart remote” (i.e., in a TV remote control) that assists the selection of content from a secondary device based on the configured metric for display on a primary device.

The above described system and method advantageously tend to help the user 8 in navigating through large amounts of multimedia content.

Optionally, one or more additional features may be incorporated.

An example of an optional additional feature is a feature that tends to prevent the user 8 from missing an interesting or exciting event. Such features may include, for example, a feature that “rewinds” (by an appropriate amount of time) a TV feed before it is displayed to the user 8 or before it is enhanced.

For example, at least a portion of a multimedia feed may be stored. Using the metric value corresponding to that multimedia feed, a start time (within that multimedia feed) of an exciting or interesting event may be determined. When that feed is displayed to the user 8, that feed may be replayed from a point in that feed prior to the determined start time of the event (by replaying some or all of the stored portion of the feed).

In some embodiments, a rewind feature may track the start times of events that the user 8 may regard as the most exciting or interesting and time-shift playback of TV feeds containing those events such that those feeds are displayed to the user 8 from a point prior to the exciting or interesting events occurring. Time shifting may involve recording (e.g., temporarily) some or all of a TV feed and then playing back some or all of the stored portion. For example, the TV feeds received by the TV and displayed to the user 8 may be stored beginning at TV-program boundaries. Alternatively the TV feeds may be stored beginning at the start of exciting or interesting events. The display 16 showing the user 8 the TV feed may continue showing the time-shifted TV feed until a catch-up event occurs. Examples of catch-up events include the end of a TV program, the end of an exciting or interesting event, or a request by the user 8 to begin watching the TV feed live.

A further example of an optional additional feature is a feature that enables a user, whilst watching a plurality of TV feeds, to choose a subset of those feeds (e.g., a single TV feed) to view on its own rather than continuing to watch the plurality of TV feeds. Upon changing from viewing a plurality of TV feeds to viewing a subset (e.g., one) of those feeds, the above described “rewind feature” may be implemented. This would tend to ensure that the user does not miss any important or interesting events that occur in the TV feeds that he has elected to view.

In other embodiments, the feeds could be provided with a delay to permit the analysis (by the media-analysis module 10) to be ahead of the presented video. Thus, the display or enhancement of a feed may be at a point in the feed prior to the exciting or notable event. Alternatively, scene-detection processes may be implemented to allow a TV feed to be displayed or enhanced from the start of a scene.

In the above embodiments, metric values (e.g., excitement metric values) for the TV feeds are determined by the TV 6. However, in other embodiments excitement information for a feed may be determined or received in a different way. For example, metric values may be provided by the content source (e.g., the service provider 2 or the provider of the multimedia content). The metric values for a feed may then be embedded in the transport stream of that feed. Also for example, metric values may be provided by a head end, e.g., as a web service front end to a service analyzing incoming feeds. Also for example, metric values may be determined by an application running on the TV 6. Also for example, if a feed is being received from an “over-the-top source,” e.g., the Internet, metric values may be provided by the content source and may be embedded in the metadata of the source (e.g., in the HTML header). Also for example, metric values may be provided by a third party (e.g., a separate on-line provider of metric values), for example as a web service front end to the service analyzing web feeds.

In the above embodiments, the process of FIG. 3 may be performed by the apparatus described above with reference to FIGS. 1 and 2. However, in other embodiments the method of FIG. 3 may be implemented by a different appropriate apparatus configured or arranged in a different way. For example, in other embodiments, some or all of the modules that perform some or all of the process steps of FIG. 3 may be in a network-centric arrangement. Also, in other embodiments, some or all of the modules that perform some or all of the process steps of FIG. 3 may be located “in the cloud.”

In the above embodiment, the invention is implemented using TV feeds. However, in other embodiments, one or more of these feeds may be a different type of multimedia feed, e.g., movies, YouTube™ videos, videos from web sites, “Apps,” etc.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1. A method of displaying multimedia feeds, the method comprising:
receiving, by a receiving module, a plurality of multimedia feeds;
for each of the plurality of multimedia feeds, acquiring, by one or more processors operatively coupled to the receiving module, a value of a metric; and
displaying, on a common display operatively connected to the receiving module and to the one or more processors, the plurality of multimedia feeds;
wherein the value of the metric is variable;
wherein the value of the metric for a particular multimedia feed and for a particular time is dependent upon either events occurring within that particular multimedia feed at or before that particular time or upon a rating, at that particular time, of that particular multimedia feed, by one or more entities; and
wherein the plurality of multimedia feeds are displayed on the common display such that a first multimedia feed is displayed in a way different from a second multimedia feed, the first multimedia feed having a first metric value, the second multimedia feed having a second metric value, the first metric value being different from the second metric value.

2. A method according to claim 1 wherein the metric value for a particular multimedia feed and for a particular time is dependent upon one or more parameters selected from the group consisting of: an excitement level of that particular multimedia feed at or before that particular time, a detection of a presence of a specific person, entity, or object in that particular multimedia feed at or before that particular time, a detection of a discussion of or reference to a specific topic in that particular multimedia feed at or before that particular time, a rating for that multimedia feed for that particular time generated by one or more members of a social network of a consumer to whom the selected multimedia feeds are displayed, and a rating for that multimedia feed for that particular time generated by a source of that multimedia feed.

3. A method according to claim 1 wherein the metric value for a particular multimedia feed and for a particular time is indicative of a level of excitement or interest of that particular multimedia feed at that particular time.

4. A method according to claim 3 further comprising:
monitoring the metric values of the multimedia feeds;
wherein the multimedia feeds are displayed such that the multimedia feed having a metric value that is indicative of a highest level of excitement or interest is displayed more prominently on the display than other multimedia feeds.

5. A method according to claim 3:
wherein the first metric value is indicative of a higher level of excitement or interest than the second metric value; and
wherein the multimedia feeds are displayed such that the first multimedia feed is displayed more prominently on the display than the second multimedia feed.

6. A method according to claim 4 wherein a prominence on the display of a multimedia feed is based at least in part on the metric value of that multimedia feed.

7. A method according to claim 4 wherein the multimedia feeds are displayed such that the first multimedia feed is displayed in a larger display window on the display than is the second multimedia feed.

8. A method according to claim 4 wherein the multimedia feeds are displayed such that the first multimedia feed is displayed at a higher resolution than the resolution at which the second multimedia feed is displayed.

9. A method according to claim 4 wherein audio relating to the first multimedia feed is played, whilst audio relating to the second multimedia feed is not played.

10. (canceled)

11. A method according to claim 1 wherein acquiring a value of a metric comprises:
for each of the plurality of multimedia feeds, performing, by the one or more processors on that multimedia feed, a media-analysis process to determine a value of the metric.

12. A method according to claim 1 wherein acquiring a value of a metric comprises:
for each of the plurality of multimedia feeds, receiving or retrieving, by the one or more processors from a further entity remote from the one or more processors, a value of the metric, that received or retrieved value of the metric having been determined by the further entity.

13. A method according to claim 1 further comprising:
from the plurality of received multimedia feeds, selecting, by the one or more processors, two or more multimedia feeds, the selection of each of those two or more multimedia feeds being dependent on the metric value for those multimedia feeds;
wherein displaying the plurality of multimedia feeds comprises displaying the selected multimedia feeds.

14.-15. (canceled)

16. A method according to claim 1 wherein the multimedia feeds are delayed by a predetermined amount of time prior to being displayed.

17. A method according to claim 1 further comprising, for a multimedia feed:
storing at least a portion of that multimedia feed;
using the metric value for that multimedia feed, identifying within that multimedia feed a start of an event; and
playing that multimedia feed from a point in that multimedia feed prior to the identified start of the event.

18. (canceled)

19. A method according to claim 1 wherein each of the plurality of multimedia feeds is a television feed.

20. Apparatus for displaying multimedia feeds, the apparatus comprising:
a receiving module configured to receive a plurality of multimedia feeds;
one or more processors operatively coupled to the receiving module and configured to, for each of the plurality of multimedia feeds, acquire a value of a metric; and
a common display operatively connected to the receiving module and to the one or more processors and configured to display the multimedia feeds;
wherein the value of the metric is variable;
wherein the value of the metric for a particular multimedia feed and for a particular time is dependent upon either events occurring within that particular multimedia feed at or before that particular time or upon a rating, at that particular time, of that particular multimedia feed, by one or more entities; and
wherein the multimedia feeds are displayed on the common display such that a first multimedia feed is displayed in way different from a second multimedia feed, the first multimedia feed having a first metric value, the second multimedia feed having a second metric value, the first metric value being different from the second metric value.
